(19) United States
(12) Patent Application Publication
(10) Pub. No.: US 2007/0171608 A1
(43) Pub. Date: Jul. 26, 2007

(54) HEAT EXCHANGE MODULE

(75) Inventor: Ching-Yu Hsu, Keelung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AMA PRECISION INC., Taipei City (TW)

(21) Appl. No.: 11/626,378

(22) Filed: Jan. 24, 2007

(30) Foreign Application Priority Data
Jan. 24, 2006 (TW) 95102571

(51) Int. Cl. G06F 1/20

(52) U.S. Cl. 361/687

(57) ABSTRACT

A heat exchange module includes a first heat conductor, a first heat-conductive rod, a second heat-conductive rod, a pivot pair, a third heat-conductive rod and a second heat conductor. The first heat-conductive rod is connected to the first heat conductor. The second heat-conductive rod is connected to the first heat-conductive rod. The pivot pair has a first pivot part and a second pivot part, wherein the first pivot part is suitable for rotating around a rotation axis relatively to the second pivot part, while the second heat-conductive rod is connected to the first pivot part. The third heat-conductive rod is connected to the second pivot part. The second heat conductor is connected to the third heat-conductive rod, wherein one of the first heat conductor and the second heat conductor is a heat-input component, while the other of the first heat conductor and the second heat conductor is a heat-output component.

### CROSS-REFERENCE TO RELATED APPLICATION

This application claims the priority benefit of Taiwan application serial no. 95102571, filed on Jan. 24, 2006. All disclosure of the Taiwan application is incorporated herein by reference.

### BACKGROUND OF THE INVENTION

1. Field of Invention

The present invention relates to a heat exchange module, and particularly to a heat exchange module having two heat conductors, whose positions can be adjusted according to the variation of the relative position between a heat-source end and a heat-dissipation end, respectively.

2. Description of the Related Art

Along with the developments of electronic technology, dazzling novel electronic products have been launched on the market to meet the consumer demands. In terms of computer, to assure a computer system being normally running, an electronic component with a higher heat power in the computer, such as a CPU (central processing unit), a memory module, a GPU (graphics processing unit) and a chipset, must be equipped with a heat-dissipation module for removing the unwanted heat energy outwards and preventing the temperature of electronic elements in operations from exceeding a normal temperature limit to avoid malfunction.

A conventional heat-dissipation module usually includes a heat sink for contacting heat-source elements, wherein the heat sink includes a base and a plurality of fins on the base, and the base is used for contacting the surface of the heat-source element, so that the heat energy of the electronic element is received by the base in a heat-conduction mode and is conducted in the same heat-conduction mode to the fins thereon. The fins are designed for purposely increasing the heat-dissipation area to advance the heat-conduction efficiency of the heat sink.

For a conventional heat-dissipation module, not only a natural convection generated by the surface of a heat sink, but also a forced air-flow provided outside can be used to advance the thermal-convection efficiency of the heat sink. For example, in addition to a heat sink, a heat-dissipation module can further include a fan assembled at a side of the heat sink for a better heat-dissipation efficiency, where the fan is employed for providing a forced air-flow.

To increase heat-dissipation area in the prior art, a heat sink is usually designed to be extended from a heat-source electronic element to the metal portion of the computer case, so as to increase the entire heat-dissipation area thereof. However, the distance between the electronic element (as a heat-source end) and the computer case (as the heat-dissipation end) is varied with different cases or different main board designs, which requires the heat sink to be designed on a case-by-case base and makes the design cost and molding cost unnecessarily increased.

### SUMMARY OF THE INVENTION

An object of the present invention is to provide a heat exchange module for transferring the heat energy from a heat-source end to a heat-dissipation end.

Another object of the present invention is to provide a heat exchange module suitable for flexibly transferring the heat energy from a heat-source end to a heat-dissipation end.

To achieve the above or other objects, the present invention provides a heat exchange module, which includes a first heat conductor, a first heat-conductive rod, a second heat-conductive rod, a pivot pair, a third heat-conductive rod and a second heat conductor. The first heat-conductive rod connects the first heat conductor. The second heat-conductive rod connects the first heat-conductive rod. The pivot pair has a first pivot part and a second pivot part, wherein the first pivot part is able to rotate around a rotation axis relatively to the second pivot part, while the second heat-conductive rod connects the first pivot part. The third heat-conductive rod connects the second pivot part. The second heat conductor connects the third heat-conductive rod, wherein one of the first heat conductor and the second heat conductor is a heat-input component, while the other is a heat-output component.

In an embodiment of the present invention, the first heat-conductive rod is connected to the first heat conductor in moveable or rotatable manner.

In an embodiment of the present invention, the second heat-conductive rod is connected to the first pivot part in moveable or rotatable manner.

In an embodiment of the present invention, the second heat-conductive rod passes through a hole in the first pivot part, so that the second heat-conductive rod is able to move along or rotate around the extension axis thereof relatively to the first pivot part.

In an embodiment of the present invention, the third heat-conductive rod is connected to the second pivot part in moveable or rotatable manner.

In an embodiment of the present invention, the third heat-conductive rod is connected to the second heat conductor in moveable or rotatable manner.

In an embodiment of the present invention, the first heat conductor is a heat sink, a heat-dissipation plate or a portion of a computer case.

In an embodiment of the present invention, the second heat conductor is a heat sink, a heat-dissipation plate or a portion of a computer case.

In an embodiment of the present invention, the first and second heat-conductive rods are two consecutive sections of a bent heat-pipe or a bent solid rod, respectively.

In an embodiment of the present invention, the first heat-conductive rod is a heat-pipe or a solid rod.

In an embodiment of the present invention, the second heat-conductive rod is a heat-pipe or a solid rod.

In an embodiment of the present invention, the third heat-conductive rod is a heat-pipe or a solid rod.

Based on the above described, the heat exchange module of the present invention serves to transfer heat energy from one heat conductor to another by using a plurality of heat-conductive rods and a pivot pair, and provides a degree of freedom or a plurality of degrees of freedom for adjusting the relative position between one heat conductor and another in one-dimensional, bi-dimensional or tri-dimensional mode by specifying a moveable or rotatable connection between the heat-conductive rods and the pivot pairs.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic exploded view of a heat exchange module provided according to an embodiment of the present invention.

FIG. 2 is a schematic assembly view of the heat exchange module in FIG. 1.

FIG. 3 is a schematic view showing the heat exchange module in the state after the relative position between the first heat conductor and the second heat conductor in FIG. 2 being adjusted.

### DESCRIPTION OF THE EMBODIMENTS

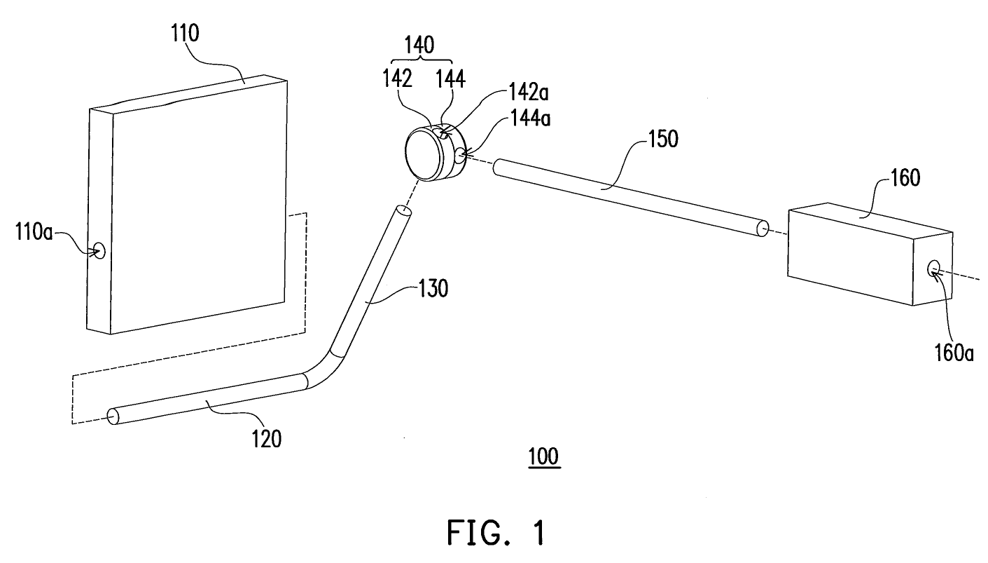

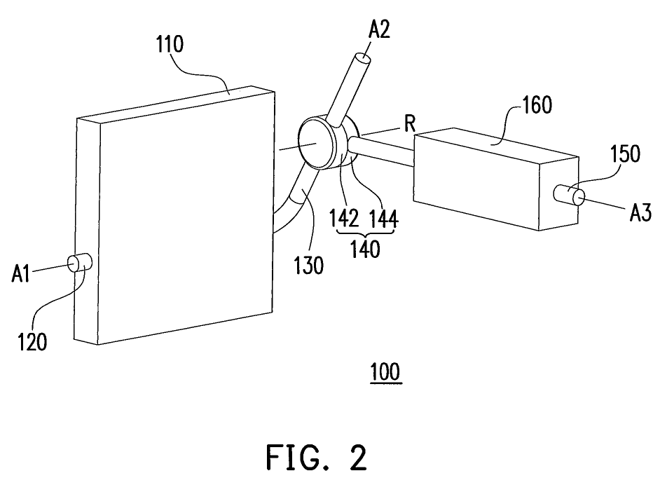

FIG. 1 and FIG. 2 are a schematic exploded view and a schematic assembly view of a heat exchange module provided according to an embodiment of the present invention. Referring to FIGS. 1 and 2, the heat exchange module 100 of the embodiment is able to transfer heat energy from a heat-source end to a heat-dissipation end. The heat-source end can be, for example, a calorific electronic element or a calorific object, and the heat-dissipation end can be, for example, a heat-dissipation module, a metal case or a space with a lower temperature than the heat-source end. The heat exchange module 100 includes a first heat conductor 110, a first heat-conductive rod 120, a second heat-conductive rod 130, a pivot pair 140, a third heat-conductive rod 150 and a second heat conductor 160.

In the embodiment, the first heat conductor 110 serves as a heat-input component for contacting the heat-source end and receiving heat energy therefrom. In contrast with the heat exchange module 100 serving as a heat-input component, the second heat conductor 160 serves as a heat-output component for contacting the heat-dissipation end and further exhausting the heat energy to the heat-dissipation end. In another embodiment, the first heat conductor 110 can alternatively serve as a heat-output component, while the second heat conductor 160 accordingly serves as a heat-input component.

The first heat-conductive rod 120 connects the first heat conductor 110, and the second heat-conductive rod 130 connects the first heat-conductive rod 120. The pivot pair 140 includes a first pivot part 142 and a second pivot part 144, wherein the first pivot part 142 is suitable for rotating around a rotation axis R relatively to the second pivot part 144, and the second heat-conductive rod 130 connects the first pivot part 142. An end of the third heat-conductive rod 150 connects the second pivot part 144, and the second heat conductor 160 connects the third heat-conductive rod 150.

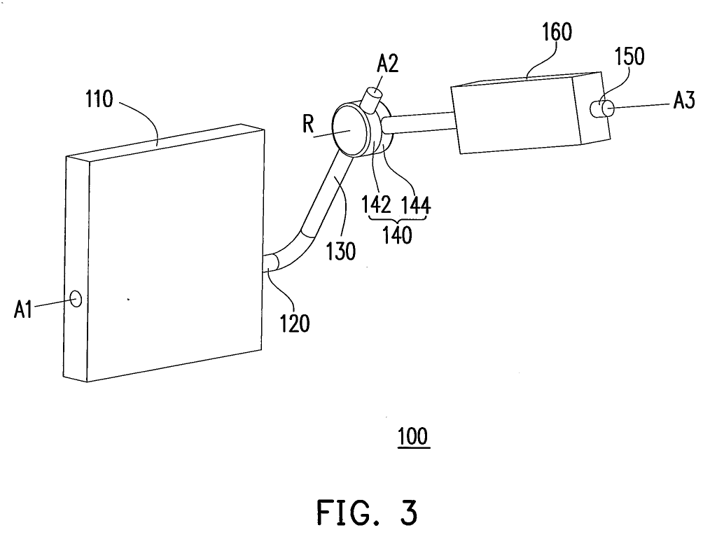

FIG. 3 is a schematic view showing the heat exchange module in the state after the relative position between the first heat conductor and the second heat conductor in FIG. 2 being adjusted. Referring to FIGS. 2 and 3, by means of a relative rotation between the first pivot part 142 and a second pivot part 144 of the pivot pair 140, the second heat conductor 160 is able to rotate relatively to the first heat conductor 110 around the rotation axis R for a position adjustment. Consequently, the second heat conductor 160 relative to the first heat conductor 110 provides one degree of freedom.

To adjust the relative position between the second heat conductor 160 and the first heat conductor 110 is for adapting a varied relative position between the heat-dissipation end and the heat-source end. In one embodiment, by changing the connection manners between the first heat conductor 110 and the first heat-conductive rod 120, the second heat-conductive rod 130 and the first pivot part 142 of the pivot pair 140, the second pivot part 144 of the pivot pair 140 and the third heat-conductive rod 150, the third heat-conductive rod 150 and the second heat conductor 160, and any of these combinations is to increase the numbers of the degree of freedom relative to the second heat conductor 160 and the first heat conductor 110.

For the connection between the first heat conductor 110 and the first heat-conductive rod 120, the first heat-conductive rod 120 is connected to the first heat conductor 110 in moveable manner or rotatable manner. To enable the first heat-conductive rod 120 to connect the first heat conductor 110 in moveable manner or rotatable manner in the embodiment, a hole 110a is made in the first heat conductor 110 and the first heat-conductive rod 120 passes through the hole 110a (as shown in FIG. 1), so that the first heat-conductive rod 120 is able to move along an extension axis A1 thereof or to rotate around the extension axis A1 relatively to the first heat conductor 110. In this way, the second heat conductor 160 is provided with two degrees of freedom relative to the first heat conductor 110, i.e. a degree of freedom of motion and a degree of freedom of rotation. It can be seen from FIGS. 2 and 3, the relative position between the second heat conductor 160 and the first heat conductor 110 can be adjusted by means of moving the first heat-conductive rod 120 along the extension axis A1 of the first heat-conductive rod 120 or rotating the first heat-conductive rod 120 around the extension axis A1 relatively to the first heat conductor 110.

For the connection between the second heat-conductive rod 130 and the first pivot part 142 of the pivot pair 140, the second heat-conductive rod 130 is connected to the first pivot part 142 of the pivot pair 140 in moveable manner or rotatable manner. To enable the second heat-conductive rod 130 to connect the first pivot part 142 in moveable manner or rotatable manner in the embodiment, a hole 142a is made in the first pivot part 142 and the second heat-conductive rod 130 passes through the hole 142a (as shown in FIG. 1), so that the second heat-conductive rod 130 is able to move along an extension axis A2 thereof or to rotate around the extension axis A2 relatively to the first pivot part 142. In this way, the second heat conductor 160 is provided with two degrees of freedom relative to the first heat conductor 110, i.e. a degree of freedom of motion and a degree of freedom of rotation. It can be seen from FIGS. 2 and 3, the relative position between the second heat conductor 160 and the first heat conductor 110 can be adjusted by means of moving the second heat-conductive rod 130 along the extension axis A2 of the second heat-conductive rod 130 or rotating the second heat-conductive rod 130 around the extension axis A2 relatively to the first pivot part 142.

For the connection between the second pivot part 144 of the pivot pair 140 and the third heat-conductive rod 150, the third heat-conductive rod 150 is connected to the second pivot part 144 of the pivot pair 140 in moveable manner or rotatable manner. To enable the third heat-conductive rod 150 to connect the second pivot part 144 in moveable manner or rotatable manner in the embodiment, a hole 144a is made in the second pivot part 144 and the third heat-conductive rod 150 passes through the hole 144a (as shown in FIG. 1), so that the third heat-conductive rod 150 is able to move along an extension axis A3 thereof or to rotate around the extension axis A3 relatively to the second pivot part 144. In this way, the second heat conductor 160 is provided with two degrees of freedom relative to the first heat conductor 110, i.e. a degree of freedom of motion and a degree of freedom of rotation. It can be seen from FIGS. 2 and 3, the relative position between the second heat conductor 160 and the first heat conductor 110 can be adjusted by means of moving the third heat-conductive rod 150 along the extension axis A3 of the third heat-conductive rod 150 or rotating the third heat-conductive rod 150 around the extension axis A3 relatively to the second pivot part 144.

For the connection between the third heat-conductive rod 150 and the second heat conductor 160, the third heat-conductive rod 150 is connected to the second heat conductor 160 in moveable manner or rotatable manner. To enable the third heat-conductive rod 150 to connect the second heat conductor 160 in moveable manner or rotatable manner in the embodiment, a hole 160a is made in the second heat conductor 160 and the third heat-conductive rod 150 passes through the hole 160a (as shown in FIG. 1), so that the third heat-conductive rod 150 is able to move along the extension axis A3 thereof or to rotate around the extension axis A3 relatively to the second heat conductor 160. In this way, the second heat conductor 160 is provided with two degrees of freedom relative to the first heat conductor 110, i.e. a degree of freedom of motion and a degree of freedom of rotation. It can be seen from FIGS. 2 and 3, the relative position between the second heat conductor 160 and the first heat conductor 110 can be adjusted by means of moving the third heat-conductive rod 150 along the extension axis A3 of the third heat-conductive rod 150 or rotating the third heat-conductive rod 150 around the extension axis A3 relatively to the second heat conductor 160.

To adjust the position of the second heat conductor 160 relative to the first heat conductor 110 in response to a varied relative position between the heat-dissipation end and the heat-source end, at least one degree of freedom, and six degrees of freedom as the maximum, with the second heat conductor 160 relative to the first heat conductor 110 is required. From the above described, it can be seen that eight degrees of freedom with the second heat conductor 160 relative to the first heat conductor 110 are available by specifying the connection manners between the components of the heat exchange module 100 (four degrees of freedom of motion and four degrees of freedom of rotation). Therefore, in the embodiment, if merely three degrees of freedom of motion are required, the degree of freedom of motion of the third heat-conductive rod 150 relative to the second pivot part 144 along the extension axis A3 or the degree of freedom of motion of the third heat-conductive rod 150 relative to the second heat conductor 160 along the extension axis A3 can be saved. Similarly, in the embodiment, if merely three degrees of freedom of rotation are required, the degree of freedom of rotation of the third heat-conductive rod 150 relative to the second pivot part 144 around the extension axis A3 or the degree of freedom of rotation of the third heat-conductive rod 150 relative to the second heat conductor 160 around the extension axis A3 can be saved.

In the embodiment, when the first heat conductor 110 serves as a heat-input component to be in contact with a heat-source end and the second heat conductor 160 serves as a heat-output component to be in contact with a heat-dissipation end, the first heat conductor 110 can be a heat sink or a heat-dissipation plate and the second heat conductor 160 would be a heat sink, a heat-dissipation plate or a portion of a computer case. On the contrary, when the second heat conductor 160 serves as a heat-input component to be in contact with a heat-source end and the first heat conductor 110 serves as a heat-output component to be in contact with a heat-dissipation end, the second heat conductor 160 can be a heat sink or a heat-dissipation plate and the first heat conductor 110 would be a heat sink, a heat-dissipation plate or a portion of a computer case. When the first heat conductor 110 or the second heat conductor 160 serves as a heat-output component of a sort of heat sinks, the heat-output component can locate preferably in a space with a temperature lower than the heat-source end or with a forced air-flow passing through for advancing the thermal-convection speed of the heat-output component.

In the embodiment, the first heat-conductive rod 120 or the second heat-conductive rod 130 can be two consecutive sections of a bent heat-pipe or a bent solid rod along different axes respectively, while the third heat-conductive rod 150 is a heat-pipe or a solid rod. In another embodiment, the first heat-conductive rod 120 and the second heat-conductive rod 130 can be a single heat-pipe or a single solid rod, respectively, and are welded together. In a further embodiment, an additional pivot pair just like the pivot pair 140 is used to connect the first heat-conductive rod 120 and the second heat-conductive rod 130, by which an additional degree of freedom or an additional plurality of degrees of freedom is provided to the second heat conductor 160 for adjusting the position relative to the first heat conductor 110.

In summary, the heat exchange module of the present invention uses a plurality of heat-conductive rods and a pivot pair to transfer the heat energy of a heat conductor to another heat conductor. In addition, by means of specifying the connection manners between the heat-conductive rods and the pivot pair, including a moveable manner and a rotatable manner, to provide a single degree of freedom or a plurality of degrees of freedom for adjusting the relative position between one heat conductor and another in one-dimensional, bi-dimensional or tri-dimensional mode.

Since the present invention is able to adjust the relative position between a heat conductor and another heat conductor in response to the varied relative position between the heat-source end and the heat-dissipation end, the heat exchange module of the present invention is applicable in various situations. By using the heat exchange module of the present invention, a heat-dissipation system design can be used in more electronic product models, which largely reduces the design cost and the molding cost.

Besides, since the heat exchange module of the present invention is capable of adjusting the relative position between a heat conductor and another heat conductor in one-dimensional, bi-dimensional or tri-dimensional mode, the position of a heat conductor, which serves as a heat-output component and is a fin-type heat sink, can by be adjusted to be located in a space with a forced air-flow passing through for advancing the thermal-convection speed of the heat-output component. Under the condition, the heat exchange module of the present invention can be regarded as a heat-dissipation module.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A heat exchange module, comprising:
a first heat conductor;
a first heat-conductive rod connected to the first heat conductor;
a second heat-conductive rod connected to the first heat-conductive rod;
a pivot pair having a first pivot part and a second pivot part, wherein the first pivot part rotates around a rotation axis and relatively to the second pivot part and the second heat-conductive rod is connected to the first pivot part;
a third heat-conductive rod connected to the second pivot part; and
a second heat conductor connected to the third heat-conductive rod, wherein one of the first heat conductor and the second heat conductor is a heat-input component, while the other of the first heat conductor and the second heat conductor is a heat-output component.

2. The heat exchange module as recited in claim 1, wherein the first heat-conductive rod is connected to the first heat conductor in moveable manner.

3. The heat exchange module as recited in claim 1, wherein the first heat-conductive rod is connected to the first heat conductor in rotatable manner.

4. The heat exchange module as recited in claim 1, wherein the second heat-conductive rod is connected to the first pivot part in moveable manner.

5. The heat exchange module as recited in claim 1, wherein the second heat-conductive rod is connected to the first pivot part in rotatable manner.

6. The heat exchange module as recited in claim 1, wherein the third heat-conductive rod is connected to the second pivot part in moveable manner.

7. The heat exchange module as recited in claim 1, wherein the third heat-conductive rod is connected to the second pivot part in rotatable manner.

8. The heat exchange module as recited in claim 1, wherein the third heat-conductive rod is connected to the second heat conductor in moveable manner.

9. The heat exchange module as recited in claim 1, wherein the third heat-conductive rod is connected to the second heat conductor in rotatable manner.

10. The heat exchange module as recited in claim 1, wherein the first heat conductor is a heat sink, a heat-dissipation plate or a portion of a computer case.

11. The heat exchange module as recited in claim 1, wherein the second heat conductor is a heat sink, a heat-dissipation plate or a portion of a computer case.

12. The heat exchange module as recited in claim 1, wherein the first heat-conductive rod and the second heat-conductive rod are two consecutive sections of a bent heat-pipe.

13. The heat exchange module as recited in claim 1, wherein the first heat-conductive rod and the second heat-conductive rod are two consecutive sections of a bent solid rod.

14. The heat exchange module as recited in claim 1, wherein the first heat-conductive rod is a heat-pipe or a solid rod.

15. The heat exchange module as recited in claim 1, wherein the second heat-conductive rod is a heat-pipe or a solid rod.

16. The heat exchange module as recited in claim 1, wherein the third heat-conductive rod is a heat-pipe or a solid rod.
